(19) United States
(12) Patent Application Publication
(10) Pub. No.: US 2016/0156550 A1
(43) Pub. Date: Jun. 2, 2016

(54) CALCULATING SPANNING TREE

(71) Applicant: HANGZHOU H3C TECHNOLOGIES CO., LTD., Zhejiang (CN)

(72) Inventor: Jianyong SONG, Beijing (CN)

(73) Assignee: Hangzhou H3C Technologies Co., Ltd., Hangzhou City (CN)

(21) Appl. No.: 14/899,772

(22) PCT Filed: Aug. 22, 2014
(86) PCT No.: PCT/CN2014/084987

§ 371 Date: Dec. 18, 2015

(30) Foreign Application Priority Data
Aug. 23, 2013 (CN) 201310372757.9

(51) Int. Cl. H04L 12/753; H04L 12/44

(52) U.S. Cl. CPC H04L 45/48; H04L 12/44

(57) ABSTRACT

According to an example of the present disclosure, in a method for calculating a spanning tree, a SDN controller virtualizes a plurality of SDN forwarding devices in a SDN as a virtual network bridge device, performs interaction of spanning tree protocol (STP) data unit packets with an external network device through the virtual network bridge device to calculate a spanning tree between the virtual network bridge device and the external network device according to a STP running on the SDN controller and information carried in a STP data unit packet from the external network device.

### BACKGROUND

The software defined network (SDN) is new network architecture. In contrast to traditional network architecture, a core idea of the SDN is that the control plane and forwarding plane are implemented in separate devices. The control plane may be implemented by a remote computing device referred to as an SDN controller. The network devices may have forwarding functions but not have control functions. The SDN controller is able to communicate with the network devices to communicate control functions. For instance the SDN controller may update a forwarding table of the forwarding device. A network application can be programmed in the control layer. The entire SDN network can be considered as a logical or a virtual whole.

With the development of the SDN, network designers take the SDN network as one of solutions of further network architecture. In a process that the SDN exists together a traditional architecture network and gradually replaces the traditional architecture network, the SDN will in the meantime still connect with the traditional architecture network.

### BRIEF DESCRIPTION OF THE DRAWINGS

FIG. 1 is a schematic diagram illustrating a structure of a SDN controller according to an example of the present disclosure;

FIG. 2 is a flowchart illustrating a method for calculating a spanning tree according to an example of the present disclosure;

FIG. 3 is a schematic diagram illustrating a connection between an external network device and a SDN according to an example of the present disclosure;

FIG. 4 is a schematic diagram illustrating a network structure when a physical topology of a SDN changes in FIG. 3 according to an example of the present disclosure;

FIG. 5 is a schematic diagram illustrating a network structure when a link in FIG. 4 recovers from a failure according to an example of the present disclosure.

### DETAILED DESCRIPTION

A method for calculating a spanning tree is provided according to an example of the present disclosure. The method may be applied to a SDN and an external network. The external network may include a network that is outside the SDN and does not support SDN functions, but connects with the SDN. A device in the external network may be referred to as an external network device. According to an example of the present disclosure, a way of calculating a spanning tree when the external network device connects with a SDN device may be provided. This may help to avoid a loops forming in the network.

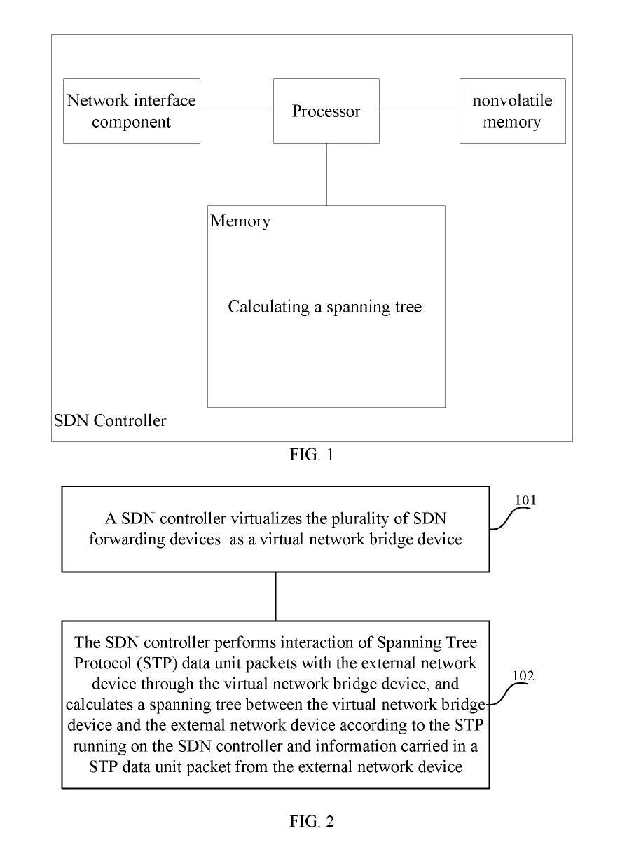

A method for calculating a spanning tree may be implemented by a SDN controller. As shown in FIG. 1, the SDN controller may include components such as a memory, a processor and a network interface. The components may be connected through a bus. The memory is an example of a non-transitory machine readable storage medium. In some examples the memory may be RAM, ROM a hard drive etc. The processor may execute machine readable instructions stored in the non-transitory storage medium. In one example the processor may read software (i.e., machine-readable instructions) stored in the memory, and may execute the software.

As shown in FIG. 2, the method includes procedures as follows.

At block 101, a SDN controller virtualizes the plurality of SDN forwarding devices as a virtual network bridge device.

In an example, the SDN controller may configure a virtual port for the virtual network bridge device, and may map the virtual port to a physical port of a SDN forwarding device that is in the SDN and which connects with the external network device.

Furthermore, the SDN controller may configure a bridge MAC for the virtual network bridge device. The bridge MAC may be a MAC address of the SDN controller. Alternatively, the SDN controller configures a new MAC address as a bridge MAC address for the virtual network bridge device. In this condition, when a failure of the SDN controller occurs and the virtual network bridge device is handed over to another SDN controller, the virtual network bridge device may sequentially communicate with the external network device through the configured bridge MAC address.

The SDN controller may configure a port identifier (ID) for the virtual port of the virtual network bridge device connecting with the external network device. The port identifier configured for each virtual port is unique in the virtual network bridge device. It is not limited whether the port identifier is same with the physical port identifier of the SDN forwarding device. A way for port mapping in the SDN forwarding device may include configuring an association relationship between port identifiers.

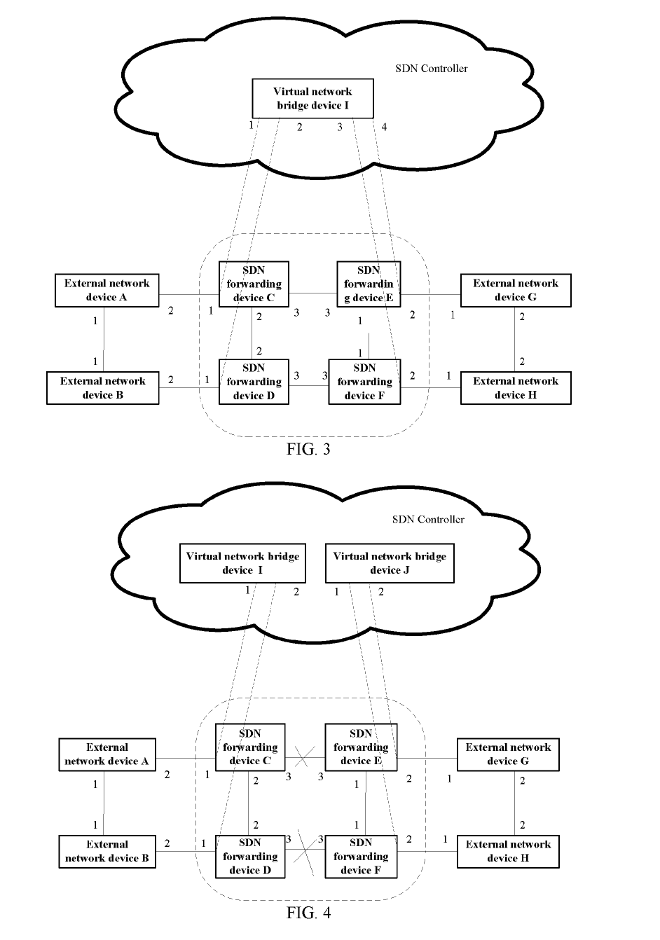

FIG. 3 is a schematic diagram illustrating a connection between a SDN and an external network device according to an example of the present disclosure. As shown in FIG. 3, the SDN controller takes a SDN forwarding device C, a SDN forwarding device D, a SDN forwarding device E and a SDN forwarding device F connecting with each other as a virtual network bridge device I. A port 1 connecting with an external network device A in the SDN forwarding device C is mapped to a port 1 of the virtual network bridge device I. A port 1 connecting with an external network device B in the SDN forwarding device D is mapped to a port 2 of the virtual network bridge device I. A port 2 connecting with an external network device Gin the SDN forwarding device E is mapped to a port 4 of the virtual network bridge device I. A port 2 connecting with an external network device H in the SDN forwarding device F is mapped to a port 3 of the virtual network bridge device I.

At block 102, the SDN controller performs interaction of Spanning Tree Protocol (STP) data unit packets with the external network device through the virtual network bridge device, and calculates a spanning tree between the virtual network bridge device and the external network device according to the STP running on the SDN controller and information carried in a STP data unit packet from the external network device.

In an example, during the process of performing the interaction of the STP data unit packets, the SDN controller may receive a STP data unit packet from the external network device through the virtual network bridge device so that according to the STP running on the SDN controller and information carried in the STP data unit packet from the external network device, the SDN controller may calculate the spanning tree between the virtual network bridge device and the external network device.

In another example, during the process of performing the interaction of the STP data unit packets, the SDN controller may transmit a STP data unit packet to the external network device through the virtual network bridge device so that according to the STP running on the external network device and information carried in the STP data unit packet from the SDN controller, the external network device may calculate the spanning tree between the SDN controller and the external network device.

In an example, the SDN controller may perform interaction of Bridge Protocol Data Unit (BPDU) packets through the virtual network bridge device. Alternatively, the SDN controller may adopt a data unit packet of another spanning tree protocol to perform interaction with the external network device.

Furthermore, before performing the interaction of the BPDU packets with the external network device through the virtual network bridge device, the SDN controller may globally enable the STP, may enable each the STP in each virtual port of the virtual network bridge device, and may transmit a BPDU packet according to the configured bridge MAC and the port identifier.

The STP running on the virtual network bridge device is same with the STP in the external network device so as to ensure that there is not a circuit in a network including the virtual network bridge device and the external network device.

The process of performing the interaction of the BPDU packets with the external network device through each virtual port may include procedures as follows.

When transmitting a BPDU packet, the SDU controller transmits the BPDU packet to the SDN forwarding device to which a physical port belongs, wherein the virtual port is mapped to the physical port. The SDN forwarding device corresponding to the physical port forwards the BPDU packet to the external network device through the corresponding physical port.

When receiving a BPDU packet, the SDN forwarding device connecting with an external network device in the SDN forwarding devices connecting with each other receives through the physical port from the physical port the BPDU packet transmitted from the external network device, and forwards the BPDU packet to the virtual port to which the physical port is mapped. The SDN controller receives the BPDU packet forwarded from the corresponding SDN forwarding device through the virtual port.

Since the new bridge MAC and the port identifier of the virtual port may be configured, for each external network device, the virtual network bridge device controlled by the SDN controller is an independent device. Thus, a device transmitting and receiving a BPDU packet is a virtual network bridge device controlled by the SDN controller.

FIG. 3 is taken as an example. The SDN controller respectively transmits a BPDU packet from a virtual port 1, a virtual port 2, a virtual port 3 and a virtual port 4. A port 1 in a SDN forwarding device C is mapped to a virtual port 1. Thus, when receiving the BPDU packet transmitted from the SDN controller through the virtual port 1, the SDN forwarding device C transmits the BPDU packet to the external network device A through the port 1. A port 1 in a SDN forwarding device D is mapped to a virtual port 2. Thus, when receiving the BPDU packet transmitted from the SDN controller through the virtual port 2, the SDN forwarding device D transmits the BPDU packet to the external network device B through the port 1. A port 2 in a SDN forwarding device E is mapped to a virtual port 4. Thus, when receiving the BPDU packet transmitted from the SDN controller through the virtual port 4, the SDN forwarding device E transmits the BPDU packet to the external network device G through the port 2. A port 2 in a SDN forwarding device F is mapped to a virtual port 3. Thus, when receiving the BPDU packet transmitted from the SDN controller through the virtual port 3, the SDN forwarding device F transmits the BPDU packet to the external network device H through the port 2.

The SDN forwarding device C receives the BPDU packet transmitted from the external network device A through the port 1, and forwards the BPDU packet to the SDN controller. The SDN forwarding device D receives the BPDU packet transmitted from the external network device B through the port 1, and forwards the BPDU packet to the SDN controller. The SDN forwarding device E receives the BPDU packet transmitted from the external network device G through the port 2, and forwards the BPDU packet to the SDN controller. The SDN forwarding device F receives the BPDU packet transmitted from the external network device H through the port 2, and forwards the BPDU packet to the SDN controller.

According to an example of the present disclosure, SDN forwarding devices controlled through the SDN controller in a SDN is taken as a virtual device, and calculates a spanning tree with the external network device.

When a network topology changed, a method for calculating a spanning tree includes procedures as follows.

When a physical topology of the external network changes or a failure of a link between external network devices directly connecting with the virtual network bridge device occurs, the SDN controller may re-calculate the spanning tree according to a STP running on the SDN controller.

When the SDN controller receives the BPDU packet notifying that a network topology changes or does not receive any BPDU packet in a preset time, the SDN controller obtains that a topology of the external network changes.

When directly detecting a link failure, the SDN controller determines that there is a failure of a link between the external network devices directly connecting with the virtual network bridge device.

In an example, the condition that the physical topology of the external network changes may not include a condition that a failure of a link between an external network device and the virtual network bridge device occurs.

FIG. 3 is also taken as an example. When a failure of a link between an external network device A and an external network device B occurs, the external network device A and the external network device B may respectively transmit the BPDU packet to the SDN controller respectively through a SDN forwarding device C and a SDN forwarding device D. When there is a failure of a link between the external network device A and the SDN forwarding device C, the SDN controller may directly detect the failure of the link. After the failure of the link between the SDN forwarding device C and the external network device A occurs, a status of the port 1 of the SDN forwarding C may change. And the SDN controller may detect a condition of changing a status in each SDN forwarding device in the SDN. In an example, the condition may include a condition of changing a status of a port. Thus, the SDN controller may directly detect the failure of the link between the external network device A and the SDN forwarding device C.

When there is a failure of a link between the external network device directly connecting with the virtual network bridge device and the SDN forwarding device connecting with the virtual network bridge device, according to a flow table issuing rule and a calculation result of the spanning tree, the SDN controller may re-issue a flow table for the SDN forwarding device determined according to the flow table issuing rule.

In an example, when there is a failure of a link between the external network device A and the SDN forwarding device C to cause that a status of a port in the SDN forwarding device C changes, the SDN forwarding device C may not receive a packet through a port 1. Thus, the SDN controller may re-issue a flow table. According to the flow table issuing rule, it is determined whether the flow table is issued for the SDN forwarding device C or for all SDN forwarding devices.

In an example, the calculation of the spanning tree may be performed in the SDN network. The SDN controller configures a preset spanning tree algorithm, and calculates a spanning tree of each SDN forwarding device in the SDN network.

A way for calculating the spanning tree in the SDN may include a centralized way for calculating a spanning tree, or a distributed way for calculating a spanning tree similar with that for calculating a STP in an external network. A spanning tree calculated in the SDN and a spanning tree calculated between the virtual network bridge device and the external network device are not impacted with each other.

When a physical topology in the SDN occurs, a spanning tree is re-calculated according to a preset spanning tree algorithm. According to a calculation result of the spanning tree, a flow table is re-generated and re-issued to all SDN forwarding devices controlled by the SDN controller.

In an example, when change of physical topology occurs in the SDN, it means defect of any SDN forwarding network device or link failure between these devices. Not including that failure between the SDN forwarding device and the external network device, i.e., the definition of above mentioned changes is exclusive of status change of port connecting with the external network.

When the physical topology in the SDN occurs, a failure of a link between SDN forwarding devices may occurs, or a failure of a certain SDN forwarding device may occurs. When the SDN forwarding devices in the SDN are divided into two or more groups, the SDN controller takes each group as an independent virtual network bridge device, and maps a physical port connecting with the external network device in a SDN forwarding device taken into each virtual network bridge device to a virtual port connecting with the external network device in the virtual network bridge device. The virtual network bridge device performs spanning tree calculation with the external network device connected with the virtual network bridge device.

It is assumed that there is a failure of a link between the SDN forwarding device C and the SDN forwarding device E and a failure of a link between the SDN forwarding device D and the SDN forwarding device F in FIG. 3. Thus, an original group of SDN forwarding devices is divided into two groups.

The SDN controller may take the SDN forwarding device E and the SDN forwarding device F as a virtual network bridge device. In an example, the SDN forwarding device C and the SDN forwarding device D is still taken as the original virtual network device. In another example, the SDN forwarding device C and the SDN forwarding device D is taken as a new virtual network device.

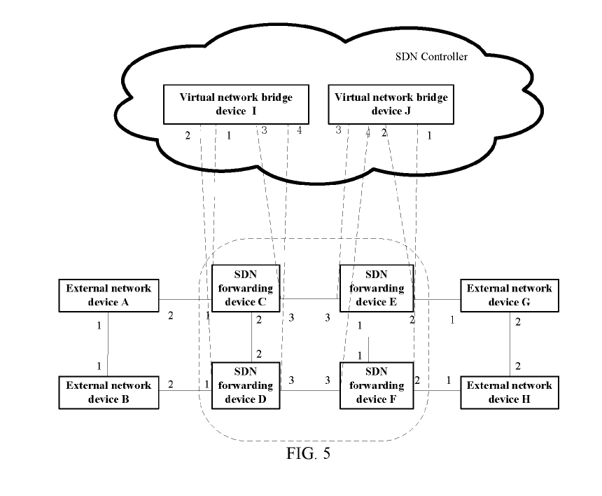

FIG. 4 is a schematic diagram illustrating a structure of a SDN when physical topology of a SDN changes in FIG. 3 according to an example of the present disclosure. In FIG. 4, there is a failure of a link between the SDN forwarding device C and the SDN forwarding device E and a failure of a link between the SDN forwarding device D and the SDN forwarding device F.

The SDN controller takes the SDN forwarding device C and the SDN forwarding device D as a virtual network bridge device I, maps a port 1 of the SDN forwarding device C to a virtual port 1 of the virtual network bridge device I, and maps a port 1 of the SDN forwarding device D to a virtual port 2 of the virtual network bridge device I.

The SDN controller takes the SDN forwarding device E and the SDN forwarding device F as a virtual network bridge device J, maps a port 2 of the SDN forwarding device E to a virtual port 2 of the virtual network bridge device J, and maps a port 2 of the SDN forwarding device F to a virtual port 1 of the virtual network bridge device J.

For the virtual network bridge I, the SDN controller calculates a spanning tree through performing BPDU packet interaction with the external network device A and the external network device B. For the virtual network bridge J, the SDN controller calculation a spanning tree through performing BPDU packet interaction with the external network device G and the external network device H.

When there is not a device as a root of an old spanning tree in the virtual network bridge device and at least one external network connecting with the virtual network bridge device, the SDN controller transmits an aging root message to a corresponding external network device through the virtual network bridge device so that the external network device performs aging for the root of the tree. For a network not including a root of an old spanning tree, a root of the old spanning tree is quickly aged in the network. The process may include procedures as follows.

It is assumed that a root of a calculated spanning tree in FIG. 3 is an external network device A. As shown in FIG. 4, a network includes a virtual network bridge device J, an external network device G and an external network device H, but does not include the root of the original spanning tree, i.e., the external network device A. Before the SDN forwarding device E and the SDN forwarding device F breaks away from the virtual network bridge device I, when the spanning tree protocol is a STP and RSTP and is out of a field of a MSTP in a BPDU packet transmitted from the SDN controller through a virtual port 3 and a virtual port 4, content of a field Message Age in the BPDU packet is Max Age, when the spanning tree protocol is in the field of the MSTP, content of a field Remaining Hops in the BPDU packet is zero, so that the old root ages as soon as possible by the external network device G and the external network device H receiving the BPDU packet ages the root of the old spanning tree as soon as possible and network convergence is fasted.

According to detail configuration of a user, the SDN controller determines whether a spanning tree is calculated between each SDN forwarding device of the virtual network bridge device I. Accordingly, according to the detail configuration of the user, the SDN controller determines whether a spanning tree is calculated between each SDN forwarding device of the virtual network bridge device J.

When a failure of a link in the SDN recovers, the SDN forwarding devices recovering connection may be re-taken as a virtual network bridge device. Alternatively, the SDN forwarding devices recovering connection may maintain current multiple virtual network bridge devices and maps the port of the link that has recovered from the failure to a virtual port of a virtual network device, and a spanning tree is calculated through perform BPDU packet interaction respectively between each virtual network bridge device and other virtual network bridge device and between external network devices.

As shown in FIG. 4, it is assumed that a failure of a link between the SDN forwarding device C and the SDN forwarding device E recovers, and a failure of a link between the SDN forwarding device D and the SDN forwarding device F recovers. A network structure in FIG. 4 may recovers to a network structure in FIG. 3, i.e., the SDN forwarding devices recovering connection are taken as a virtual network bridge device. Alternatively, two virtual network bridge devices may be maintained. FIG. 5 is a schematic diagram illustrating a structure of a SND network when recovery of a failure link in FIG. 4 occurs according to an example of the present disclosure. In FIG. 5, the port 3 of the SDN forwarding device C is mapped to the virtual port 3 of the virtual network bridge device I. The port 3 of the SDN forwarding device D is mapped to the virtual port 4 of the virtual network bridge device I. Mapping relationships respectively between a virtual port 1 of the virtual network bridge device I and a physical port of the SDN forwarding device C and between the virtual port 2 of the virtual network bridge device I and the physical port of the SDN forwarding device D are not changed.

The processing for the virtual network bridge device J is same with that for the virtual network bridge device I, which is not described repeatedly herein.

In a network structure in FIG. 5, a spanning tree is calculated among an external network device A, an external network device B, a virtual network bridge device I, a virtual network bridge device J, an external network device G and an external network device H. In the entire network, the virtual network bridge device I and the virtual network bridge device J are respectively taken as a device in a process of calculating a spanning tree.

The SDN controller transmits and receives a BPDU packet through virtual ports 1-4 of a virtual network bridge device I. The SDN controller transmits and receives a BPDU packet through virtual ports 1-4 of a virtual network bridge device J.

It can be seen from the above that, in a method, a SDN controller takes SDN forwarding devices connecting with each other in a SDN as a virtual network bridge device, mapping a physical port of a SDN forwarding device connecting with an external network device in the SDN to a virtual port connecting with the external network device in the virtual network bridge device. The SDN controller performs interaction of STP data unit packets with the external network device through the virtual port, and calculates a spanning tree between the virtual network bridge device and the external network device through running a STP. Thus, a spanning tree covering both the external network and the SDN network may be formed. In this way a loop in layer-2 of the network may be avoided.

What is claimed is:

1. A method for calculating a spanning tree, comprising:
virtualising, by a SDN (Software Defined Network) controller, a plurality of SDN forwarding devices in a SDN as a virtual network bridge device;
performing, by the SDN controller, interaction of spanning tree protocol (STP) data unit packets with an external network device through the virtual network bridge device to calculate a spanning tree between the virtual network bridge device and the external network device according to a STP running on the SDN controller and information carried in a STP data unit packet from the external network device.

2. The method of claim 1, further comprising:
configuring, by the SDN controller, a virtual port for the virtual network bridge device;
mapping, by the SDN controller, the virtual port to a physical port of a SDN forwarding device that is connected with the external network device.

3. The method of claim 1, further comprising:
when a physical topology of the external network changes or a failure of a link between an external network device directly connected with the virtual network bridge device occurs, re-calculating, by the SDN controller, a spanning tree according to the STP running on the SDN controller;
when the failure of the link between the external network device directly connecting with the virtual network bridge device occurs, according to a flow table issuing rule and a calculation result of re-calculating the spanning tree, re-issuing, by the SDN controller, a flow table for a SDN forwarding device determined according to the flow table issuing rule;
when the physical topology of the SDN changes, re-calculating, by the SDN controller, a spanning tree according to a preset spanning tree algorithm, re-generating a flow table according to a calculation result of re-calculating the spanning tree, and issuing the flow table to all SDN forwarding devices controlled by the SDN controller.

4. The method of claim 3, further comprising:
when the physical topology of the SDN changes and the SDN forwarding devices connecting with each other in the SDN are divided into two or more groups, virtualising, by the SDN controller, each respective group of the SDN forwarding devices as a respective virtual network bridge device;
mapping, by the SDN controller, a virtual port of a first virtual network bridge device corresponding to a first group of SDN forwarding devices to a physical port of a SDN forwarding device belonging to said virtual network bridge devices; said physical port connecting with an external network device;
calculating a spanning tree with the external network device connecting with the first virtual network bridge device through the virtual port of the virtual network bridge device.

5. The method of claim 4, further comprising:
before calculating the spanning tree with the external network device connecting with the first virtual network bridge device through the virtual port of the virtual network bridge device, when there is not a device as a root of an old spanning tree in the first virtual network bridge device and the external network connecting with the first virtual network bridge device, transmitting, by the SDN controller, an root aging message to the external network device, so that the external network device performs aging for the root of the old spanning tree.

6. The method of claim 4, further comprising:
in response to the link of the SDN recovering from a failure, re-forming, by the SDN controller, the virtual network bridge device to include the SDN forwarding devices recovering the link; or
mapping the virtual port of the virtual network bridge device to the physical port of the link recovering from a failure, performing interaction of data unit packets between external network devices connecting with each virtual network bridge device to calculate a spanning tree.

7. A software defined network (SDN) controller, comprising:
a processor and a non-transitory storage medium storing machine readable instructions that are executable by the processor to:
virtualize a plurality of SDN forwarding devices that are connected with each other in a SDN as a virtual network bridge device;
perform interaction of spanning tree protocol (STP) data unit packets with an external network device through the virtual network bridge device to calculate a spanning tree between the virtual network bridge device and the external network device according to a STP running on the SDN controller and information carried in a STP data unit packet from the external network device.

8. The SDN controller of claim 7, wherein the instructions are further to:
configure a virtual port for the virtual network bridge device;
map the virtual port to a physical port of a SDN forwarding device connected with the external network device in the SDN forwarding devices.

9. The SDN controller of claim 7, wherein instructions are further to:
when a physical topology of the external network changes or a failure of a link between an external network device directly connected with the virtual network bridge device occurs, re-calculate a spanning tree according to the STP running on the SDN controller;
when the failure of the link between the external network device directly connecting with the virtual network bridge device occurs, according to a flow table issuing rule and a calculation result of re-calculating the spanning tree, re-issue a flow table for a SDN forwarding device determined according to the flow table issuing rule;
when the physical topology of the SDN changes, re-calculating, by the SDN controller, a spanning tree according to a preset spanning tree algorithm, re-generate a flow table according to a calculation result of re-calculating the spanning tree, and issue the flow table to all SDN forwarding devices controlled by the SDN controller.

10. The SDN controller of claim 9, wherein instructions are further to:
when the physical topology of the SDN controller changes and the SDN forwarding devices connecting with each other in the SDN are divided into two or more groups, virtualize each respective group of the SDN forwarding devices as a respective virtual network bridge device;
map a virtual port of a first virtual network bridge device corresponding to a first group of SDN forwarding devices to a physical port of a SDN forwarding device of said first group; said physical port of the SDN forwarding device being a port that is connected with an external network device;
calculate a spanning tree with the external network device connecting with the first virtual network bridge device through the virtual port of the virtual network bridge device.

11. The SDN controller of claim 10, wherein instructions are further to:
before calculating the spanning tree with the external network device connecting with the first virtual network bridge device through the virtual port of the virtual network bridge device, when there is not a device as a root of an old spanning tree in the first virtual network bridge device and the external network connecting with the first virtual network bridge device, transmit an root aging message to an external network device, so that the external network device performs aging for the root of the old spanning tree.

12. The SDN controller of claim 10, wherein the instructions are further to:
in response to the link of the SDN recovering from a failure, re-form the virtual network bridge device to include the SDN forwarding devices recovering the link; or
map the virtual port of the virtual network bridge device to the physical port of the link recovering from a failure, performing interaction of data unit packets between external network devices connected with each virtual network bridge device to calculate a spanning tree.
